(19) United States
(12) Patent Application Publication
(10) Pub. No.: US 2024/0430877 A1
(43) Pub. Date: Dec. 26, 2024

(54) GRANT-FREE RESOURCE CONFIGURATION METHOD AND APPARATUS

(71) Applicant: HUAWEI TECHNOLOGIES CO., LTD., Shenzhen (CN)

(72) Inventors: Lei WANG, Shanghai (CN); Fan WEI, Shenzhen (CN); Xiuqiang XU, Shanghai (CN)

(21) Appl. No.: 18/825,801

(22) Filed: Sep. 5, 2024

Related U.S. Application Data
(63) Continuation of application No. PCT/CN2023/075159, filed on Feb. 9, 2023.

(30) Foreign Application Priority Data
Mar. 8, 2022 (CN) 202210228183.7

(51) Int. Cl. H04W 72/115

(52) U.S. Cl. CPC H04W 72/115

(57) ABSTRACT

A user equipment receives first indication information from a network device, where the first indication information indicates a status of each resource block group in a grant-free GF resource, the GF resource includes one or more resource block groups, each resource block group includes at least one resource block, and a status of one resource block group includes a congested state or an idle state. The user equipment performs first communication with the network device by using a first resource, where the first resource is determined based on the first indication information, and the first resource is at least one resource block group in the GF resource.

### CROSS-REFERENCE TO RELATED APPLICATIONS

This application is a continuation of International Application No. PCT/CN2023/075159, filed on Feb. 9, 2023, which claims priority to Chinese Patent Application No. 202210228183.7, filed on Mar. 8, 2022. The disclosures of the aforementioned applications are hereby incorporated by reference in their entireties.

### TECHNICAL FIELD

Embodiments of this application relate to the communication field, and more specifically, to a grant-free resource configuration method and apparatus.

### BACKGROUND

A low-latency service is an important scenario in a 5th generation mobile communication technology (5th generation, 5G). When uplink data transmission is performed for the low-latency service, grant-free (grant-free, GF) data uploading needs to be supported, to reduce time of signaling exchange between “sending a scheduling request by a user equipment (user equipment, UE)” and “sending a resource indication of the uplink data transmission to the UE” and meet a low-latency indicator requirement.

In a 5G mobile communication system, a GF transmission mechanism is introduced into an existing technical solution. In GF transmission, a transmission resource and a transmission parameter of a user are preconfigured or semi-statically configured. GF may be used to share a resource, but a possibility of a resource collision is increased when users select a same resource.

Although a GF resource transmission mechanism in a conventional technology reduces signaling overheads and reduces a transmission latency, because resources selected by users are not scheduled, the resource collision occurs among a plurality of users, and a quantity of users simultaneously performing transmission on a resource exceeds a demodulation capability of a receiver. As a result, performance of accessing a network device by the plurality of users is reduced sharply.

Therefore, a grant-free resource configuration method is urgently needed, to reduce the possibility of the resource collision and improve a success rate of GF resource transmission.

### SUMMARY

Embodiments of this application provide a grant-free resource configuration method and apparatus, to resolve a problem that a resource collision may occur when a plurality of user equipments transmit information because resources selected by the user equipments are not scheduled. The method provided in this application can improve transmission performance of the user equipment.

According to a first aspect, a grant-free resource configuration method is provided. The method includes: A user equipment receives first indication information from a network device, where the first indication information indicates a status of each resource block group in a grant-free GF resource, the GF resource includes one or more resource block groups, each resource block group includes at least one resource block, and the status includes a congested state or an idle state. The user equipment performs first communication with the network device by using a first resource, where the first resource is determined based on the first indication information, and the first resource is at least one resource block group in the GF resource.

According to the grant-free resource configuration method provided in this application, the user equipment determines, based on the first indication information sent by the network device, the first resource for performing the first communication with the network device, so that a GF resource collision of the user equipment in a communication process can be reduced, access efficiency can be improved, and transmission performance of the user equipment can be effectively improved.

With reference to the first aspect, in some implementations of the first aspect, that the first resource is determined based on the first indication information includes: The first resource is determined based on the first indication information and a second resource, where the second resource is at least one resource block group in the GF resource, the second resource is a resource used for second communication between the user equipment and the network device, the second communication fails, and the second communication is performed before the first communication.

Based on the foregoing solution, when the user equipment performs the second communication with the network device by using the second resource, the second communication fails. After the user equipment receives the first indication information from the network device, the user equipment determines the first resource based on the first indication information and the second resource, and then the user equipment performs the first communication with the network device based on the determined first resource. Therefore, communication performance between the user equipment and the network device is improved, and a transmission success rate of the user equipment is increased.

With reference to the first aspect, in some implementations of the first aspect, the status further includes a congestion level and/or an idle level.

Based on the foregoing solution, the user equipment determines the first resource based on a congestion level and/or an idle level of a resource block group, so that a resource collision can be more effectively reduced.

With reference to the first aspect, in some implementations of the first aspect, the first indication information further indicates a selection weight of one or more resource block groups, or the first indication information further indicates a selection weight of a resource block group in the congested state and/or a selection weight of a resource block group in the idle state.

Based on the foregoing solution, the user equipment determines the first resource based on the selection weight of the one or more resource block groups or based on the selection weight of the resource block group in the congested state and/or the selection weight of the resource block group in the idle state, so that transmission performance of the user equipment can be effectively improved.

With reference to the first aspect, in some implementations of the first aspect, the first resource does not include a third resource, and the third resource is at least one resource block group in the GF resource.

With reference to the first aspect, in some implementations of the first aspect, the third resource is a resource invoked by a non-GF service.

Based on the foregoing solution, when the third resource is invoked by the non-GF service, and when the user equipment selects the first resource, a resource block group that has been invoked by another service can be effectively avoided. A probability of selecting the resource block group invoked by the non-GF service is 0.

With reference to the first aspect, in some implementations of the first aspect, the first indication information includes: an index of the resource block group in the congested state in the GF resource; an index of the resource block group in the idle state in the GF resource; or a first bitmap, where the first bitmap includes N bits, the GF resource includes N resource block groups, the N bits are in one-to-one correspondence with the N resource block groups, and each bit indicates a status of a corresponding resource block group.

With reference to the first aspect, in some implementations of the first aspect, content of the first communication performed by the user equipment and the network device includes one or more of the following: a reference signal, a preamble, a physical uplink shared channel PUSCH, a physical uplink control channel PUCCH, an uplink control signal UCI, a radio resource control RRC message, and control plane UP data.

According to a second aspect, a grant-free resource configuration method is provided. The method includes: A network device sends first indication information to a user equipment, where the first indication information indicates a status of each resource block group in a grant-free GF resource, the GF resource includes one or more resource block groups, each resource block group includes at least one resource block, and the status includes a congested state or an idle state. The network device performs first communication with the user equipment, where the first communication is performed on a first resource, the first resource is determined based on the first indication information, and the first resource is at least one resource block group in the GF resource.

According to the grant-free resource configuration method provided in this application, the network device sends the first indication information to the user equipment, where the first indication information indicates the status of each resource block group in the GF resource, and the user equipment determines the first resource based on the first indication information, so that a GF resource collision that may occur in a communication process between the network device and the user equipment can be reduced, and transmission performance can be improved.

With reference to the second aspect, in some implementations of the second aspect, that the first resource is determined based on the first indication includes: The first resource is determined based on the first indication information and a second resource, where the second resource is at least one resource block group in the GF resource, the second resource is a resource used for second communication between the user equipment and the network device, the second communication fails, and the second communication is performed before the first communication.

Based on the foregoing solution, the second communication performed by the network device and the user equipment is performed on the second resource and fails. After the user equipment receives the first indication information from the network device, the user equipment determines the first resource based on the first indication information and the second resource, and then the user equipment performs the first communication with the network device based on the determined first resource. Therefore, communication performance between the user equipment and the network device is improved, and a transmission success rate of the user equipment is increased.

With reference to the second aspect, in some implementations of the second aspect, the status further includes a congestion level and/or an idle level.

With reference to the second aspect, in some implementations of the second aspect, the first indication information further indicates a selection weight of one or more resource block groups, or the first indication information further indicates a selection weight of a resource block group in the congested state and/or a selection weight of a resource block group in the idle state.

With reference to the second aspect, in some implementations of the second aspect, the first resource does not include a third resource, and the third resource is at least one resource block group in the GF resource.

With reference to the second aspect, in some implementations of the second aspect, the third resource is a resource invoked by a non-GF service.

Based on the foregoing solution, when the third resource is invoked by the non-GF service, and when the user equipment selects the first resource, a resource block group that has been invoked by another service can be effectively avoided. A probability of selecting the resource block group invoked by the non-GF service is 0.

With reference to the second aspect, in some implementations of the second aspect, the first indication information includes: an index of the resource block group in the congested state in the GF resource; an index of the resource block group in the idle state in the GF resource; or a first bitmap bitmap, where the first bitmap includes N bits, the GF resource includes N resource block groups, the N bits are in one-to-one correspondence with the N resource block groups, and each bit indicates a status of a corresponding resource block group.

With reference to the second aspect, in some implementations of the second aspect, content of the first communication performed by the network device and the user equipment includes one or more of the following: a reference signal, a preamble, a physical uplink shared channel PUSCH, a physical uplink control channel PUCCH, an uplink control signal UCI, a radio resource control RRC message, and control plane UP data.

According to a third aspect, a grant-free resource configuration apparatus is provided. The apparatus includes: a transceiver unit, configured to receive first indication information from a network device, where the first indication information indicates a status of each resource block group in a grant-free GF resource, the GF resource includes one or more resource block groups, each resource block group includes at least one resource block, and the status includes a congested state or an idle state. The transceiver unit is further configured to perform first communication with the network device on a first resource, where the first resource is determined based on the first indication information, and the first resource is at least one resource block group in the GF resource.

With reference to the third aspect, in some implementations of the third aspect, that the first resource is determined based on the first indication information includes: The first resource is determined based on the first indication information and a second resource, where the second resource is at least one resource block group in the GF resource, the second resource is a resource used for second communication between the apparatus and the network device, the second communication fails, and the second communication is performed before the first communication.

With reference to the third aspect, in some implementations of the third aspect, the status further includes a congestion level and/or an idle level.

With reference to the third aspect, in some implementations of the third aspect, the first indication information further indicates a selection weight of one or more resource block groups, or the first indication information further indicates a selection weight of a resource block group in the congested state and/or a selection weight of a resource block group in the idle state.

With reference to the third aspect, in some implementations of the third aspect, the first resource does not include a third resource, and the third resource is at least one resource block group in the GF resource.

With reference to the third aspect, in some implementations of the third aspect, the third resource is a resource invoked by a non-GF service.

With reference to the third aspect, in some implementations of the third aspect, the first indication information further includes: an index of the resource block group in the congested state in the GF resource; an index of the resource block group in the idle state in the GF resource; or a first bitmap bitmap, where the first bitmap includes N bits, the GF resource includes N resource block groups, the N bits are in one-to-one correspondence with the N resource block groups, and each bit indicates a status of a corresponding resource block group. With reference to the third aspect, in some implementations of the third aspect, that the transceiver unit transmits first information by using the first resource includes: A processing unit is configured to select the first resource from the GF resource based on an equal probability coefficient. Alternatively, the apparatus selects the first resource from the GF resource based on an unequal probability coefficient.

With reference to the third aspect, in some implementations of the third aspect, content of the first communication performed by the user equipment and the network device includes one or more of the following: a reference signal, a preamble, a physical uplink shared channel PUSCH, a physical uplink control channel PUCCH, an uplink control signal UCI, a radio resource control RRC message, and control plane UP data.

With reference to the third aspect, in some implementations of the third aspect, the processing unit is further configured to select the first resource from a non-congested GF resource based on the equal probability coefficient, or the processing unit is further configured to select the first resource from an idle GF resource based on the equal probability coefficient.

With reference to the third aspect, in some implementations of the third aspect, the unequal probability coefficient indicates a selection probability of a congested resource block group and/or a selection probability of an idle resource block group, and the processing unit is further configured to reduce the selection probability of the congested resource block group and/or increase the selection probability of the idle resource block group based on a GF resource selection parameter, where the GF resource selection parameter is received by the apparatus from the network device.

With reference to the third aspect, in some implementations of the third aspect, the processing unit is further configured to increase the selection probability of the idle resource block group based on the GF resource selection parameter; and the processing unit is further configured to select the first resource from the non-congested GF resource based on the unequal probability coefficient.

According to a fourth aspect, a grant-free resource configuration apparatus is provided. The apparatus includes: a transceiver unit, configured to send first indication information to a user equipment, where the first indication information indicates a status of each resource block group in a grant-free GF resource, the GF resource includes one or more resource block groups, each resource block group includes at least one resource block, and the status includes a congested state or an idle state. The transceiver unit is further configured to perform first communication between the apparatus and the user equipment, where the first communication is performed on a first resource, the first resource is determined based on the first indication information, and the first resource is at least one resource block group in the GF resource.

With reference to the fourth aspect, in some implementations of the fourth aspect, the first resource is determined based on the first indication information and a second resource, where the second resource is at least one resource block group in the GF resource, the second resource is a resource used for second communication between the user equipment and the apparatus, the second communication fails, and the second communication is performed before the first communication.

With reference to the fourth aspect, in some implementations of the fourth aspect, the status further includes a congestion level and/or an idle level.

With reference to the fourth aspect, in some implementations of the fourth aspect, the first indication information further indicates a selection weight of one or more resource block groups, or the first indication information further indicates a selection weight of a resource block group in the congested state and/or a selection weight of a resource block group in the idle state.

With reference to the fourth aspect, in some implementations of the fourth aspect, the first resource does not include a third resource, and the third resource is at least one resource block group in the GF resource.

With reference to the fourth aspect, in some implementations of the fourth aspect, the third resource is a resource invoked by a non-GF service.

With reference to the fourth aspect, in some implementations of the fourth aspect, the first indication information further includes: an index of the resource block group in the congested state in the GF resource; an index of the resource block group in the idle state in the GF resource; or a first bitmap bitmap, where the first bitmap includes N bits, the GF resource includes N resource block groups, the N bits are in one-to-one correspondence with the N resource block groups, and each bit indicates a status of a corresponding resource block group.

With reference to the fourth aspect, in some implementations of the fourth aspect, content of the first communication performed by the apparatus and the user equipment includes one or more of the following: a reference signal, a preamble, a physical uplink shared channel PUSCH, a physical uplink control channel PUCCH, an uplink control signal UCI, a radio resource control RRC message, and control plane UP data.

According to a fifth aspect, a grant-free resource configuration apparatus is provided. The apparatus is configured to execute units or modules such as a processing unit and/or a communication unit in the method in any one of the first aspect, the second aspect, and possible implementations of the first aspect and the second aspect.

In an implementation, the apparatus is a network element. When the apparatus is the network element, the communication unit may be a transceiver or an input/output interface, and the processing unit may be at least one processor. Optionally, the transceiver may be a transceiver circuit. Optionally, the input/output interface may be an input/output circuit.

In another implementation, the apparatus is a chip, a chip system, or a circuit used in a network element. When the apparatus is the chip, the chip system, or the circuit used in the network element, the communication unit may be an input/output interface, an interface circuit, an output circuit, an input circuit, a pin, a related circuit, or the like on the chip, the chip system, or the circuit, and the processing unit may be at least one processor, a processing circuit, a logic circuit, or the like.

According to a sixth aspect, a communication apparatus is provided. The apparatus includes at least one processor, configured to execute a computer program or instructions stored in a memory, to perform the method according to any one of possible implementations of the first aspect and the second aspect. Optionally, the apparatus further includes the memory, configured to store the computer program or the instructions. Optionally, the apparatus further includes a communication interface, and the processor reads, through the communication interface, the computer program or the instructions stored in the memory.

In an implementation, the apparatus is a network element.

In another implementation, the apparatus is a chip, a chip system, or a circuit used in a network element.

According to a seventh aspect, this application provides a processor, configured to perform the method according to the foregoing aspect.

Operations such as sending and obtaining/receiving related to the processor may be understood as operations such as output and receiving or input of the processor, or operations such as sending and receiving performed by a radio frequency circuit and an antenna, unless otherwise specified, or provided that the operations do not contradict actual functions or internal logic of the operations in related descriptions. This is not limited in this application.

According to an eighth aspect, a computer-readable storage medium is provided. The computer-readable medium stores program code to be executed by a device, and the program code includes the method according to any one of possible implementations of the first aspect and the second aspect.

According to a ninth aspect, a computer program product including instructions is provided. When the computer program product is run on a computer, the computer is enabled to perform the method according to any one of possible implementations of the first aspect and the second aspect.

According to a tenth aspect, a communication system is provided, including one or more of the foregoing user equipment and the foregoing network device.

### BRIEF DESCRIPTION OF DRAWINGS

FIG. 1 is a diagram of a grant-free resource transmission mode;

FIG. 2 is a diagram of a transmission method for periodic configuration of a grant-free resource;

FIG. 3 is a diagram of a grant-free resource configuration method according to an embodiment of this application;

FIG. 4 is a diagram of a grant-free resource configuration method according to an embodiment of this application;

FIG. 5 is a diagram of another grant-free resource configuration method according to an embodiment of this application;

FIG. 6 is a schematic block diagram of a grant-free resource configuration apparatus according to an embodiment of this application; and

FIG. 7 is a schematic block diagram of another grant-free resource configuration apparatus according to an embodiment of this application.

### DESCRIPTION OF EMBODIMENTS

The following describes the technical solutions of embodiments in this application with reference to the accompanying drawings.

The technical solutions provided in this application may be applied to various communication systems, for example, a 5th generation (5th generation, 5G) or new radio (new radio, NR) system, a long term evolution (long term evolution, LTE) system, an LTE frequency division duplex (frequency division duplex, FDD) system, an LTE time division duplex (time division duplex, TDD) system, and three application scenarios of a 5th generation (5th generation, 5G) mobile communication system: enhanced mobile broadband (enhanced mobile broadband, eMBB), ultra-reliable and low latency communications (ultra-reliable and low latency communications, URLLC), massive machine type communication (massive machine type communication, mMTC). The technical solutions provided in this application may be further applied to a future communication system, for example, a 6th generation (6th generation, 6G) mobile communication system. The technical solutions provided in this application may be further applied to device-to-device (device-to-device, D2D) communication, vehicle-to-everything (vehicle-to-everything, V2X) communication, machine-to-machine (machine-to-machine, M2M) communication, machine type communication (machine type communication, MTC), an internet of things (internet of things, IoT) communication system, or other communication systems.

A network device in embodiments of this application is an apparatus that is deployed in a radio access network and that provides a wireless communication function for a mobile station (mobile station, MS), for example, a base station. The base station may include a macro base station, a micro base station (which is also referred to as a small cell), a relay station, an access point, and the like in various forms. In systems for which different radio access technologies are used, names of a device having a base station function may be different. For example, in a 3rd generation (3rd generation, 3G) system, the device is referred to as a NodeB (NodeB). In an LTE system, the device is referred to as an evolved NodeB (evolved NodeB, eNB, or eNodeB). In a 5G system, the device carries a next generation NodeB (next generation NodeB, gNB), and the like. In addition, the network device may alternatively be a device implementing the base station function in device-to-device (device-to-device, D2D), machine type communication, and internet of vehicles communication, a satellite device, a base station device in a future communication network, and the like. For ease of description, in all embodiments of this application, the apparatus that provides the wireless communication function for the MS is collectively referred to as a network device, a base station, or a BS (base station). In this application, the base station may also be referred to as a base station device.

A user equipment (or a terminal device, a terminal, or a user) in embodiments of this application includes various handheld devices, vehicle-mounted devices, wearable devices, computing devices, or other processing devices having a wireless communication function, and may be specifically a user equipment (user equipment, UE), an access terminal, a subscriber unit, a subscriber station, a mobile station, a remote station, a remote terminal, a mobile device, a user terminal, a terminal, a wireless communication device, a user agent, or a user apparatus. Alternatively, the terminal device may be an unmanned aerial vehicle, a satellite phone, a cellular phone, a smartphone, a wireless data card, a wireless modem, a machine type communication device (machine type communication, MTC), a terminal device in a 5G network, a future communication network, or the like. The terminal device is also be referred to as a user equipment (user equipment, UE), a terminal, or the like.

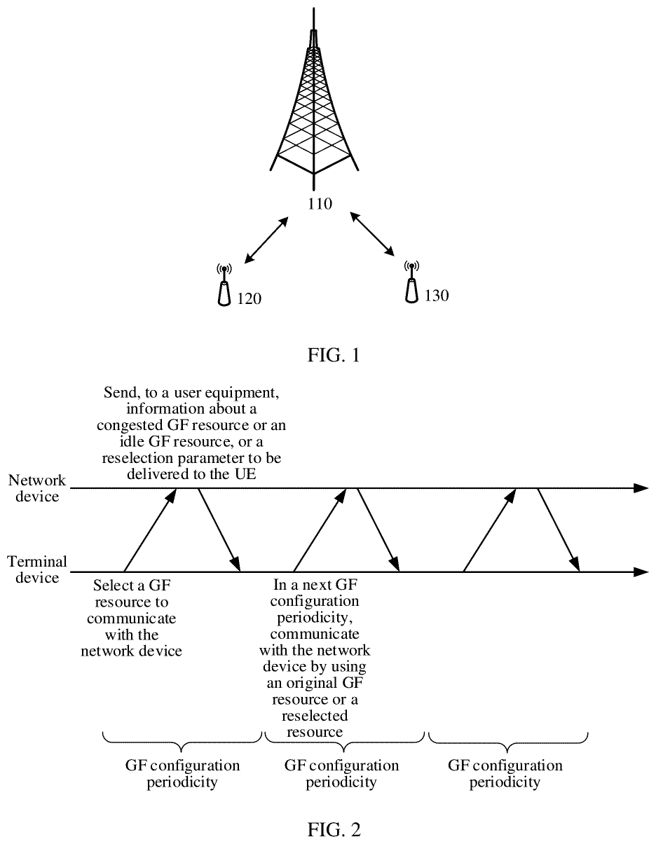

FIG. 1 shows an example of an architecture of a communication system to which an embodiment of this application is applicable. As shown in FIG. 1, the communication system includes one or more network devices (for example, 110 in FIG. 1). The network device 110 communicates with one or more terminal devices, for example, terminal devices 120 and 130 in FIG. 1. It should be understood that, in FIG. 1, only one network device 110 and two terminal devices 120 and 130 are used as an example. The communication system is not limited to including more network devices, and each network device is not limited to communicating with one or more terminal devices.

In addition, communication between the network device and the terminal device may be uplink transmission, or may be downlink transmission. This is not limited. For example, in the downlink transmission, a transmitting end in this application is the network device, for example, a base station device, and a receiving end is the terminal device. In the uplink transmission, a transmitting end in this application is the terminal device, and a receiving end is the network device, for example, a base station device.

For ease of understanding of embodiments of this application, several basic concepts in embodiments of this application are briefly described. It should be understood that basic concepts described below are briefly described by using basic concepts specified in a current protocol as an example, but embodiments of this application are not limited to being applied only to a currently existing system. Therefore, names appearing when the currently existing system is used as an example for description are all functional descriptions, and specific names are not limited, indicate only functions, and may be correspondingly expanded to another system, for example, a 6G system or a future communication system.

1. Enhanced Mobile Broadband eMBB

The enhanced mobile broadband is a people-centric application scenario, and is mainly characterized by an ultra-high data transmission rate, mobility assurance in wide coverage, and the like. This is the most intuitive improvement of a mobile network speed. In the future, requirements of more applications for the mobile network speed will be met. From a perspective of the eMBB, the eMBB is an upgrade of an original mobile network, so that people experience an ultimate network speed. Therefore, the enhanced mobile broadband (eMBB) is a core application scenario oriented to a personal consumption market in an early stage of 5G development.

The enhanced mobile broadband provides a better internet access service for a user based on better network coverage and a higher transmission rate of 5G, so that a higher internet access rate and more stable transmission are achieved for wireless internet access. The most intuitive experience for the user is that a network speed is greatly improved. Even when the user watches a 4K high-definition video, a peak value can reach 10 Gbps.

### 2. Ultra-Reliable and Low Latency Communications URLLC

The URLLC has two basic features: high reliability and a low latency, and may be widely applied to augmented reality (augmented reality, AR)/virtual reality (virtual reality, VR), an industrial control system, transportation and transport (such as self-driving), management of a smart grid and a smart home, interactive remote medical diagnosis, and the like.

In this scenario, a connection latency should reach a level of 1 ms, and a high-reliability (99.999%) connection should be supported in high-speed mobility (500 km/h). This scenario is more oriented to special applications such as an internet of vehicles, industrial control, and telemedicine. These applications have extremely high potential value in the future. In the future, the society will become intelligent. This requires a network in this scenario. These applications have extremely high requirements on security and reliability.

3. Massive Machine-Type Communication mMTC

In the “massive machine-type communication”, a powerful connection capability of 5G can quickly promote in-depth integration of vertical industries (a smart city, a smart home, and environment monitoring, and the like). With all things connected, lifestyles of people may also change greatly. In this scenario, a data rate is low and latency-insensitiveness is supported; connections appear in all aspects of life; costs of a terminal are lower; and a battery lifespan is longer and battery reliability is higher. This truly implements the interconnection of all things. In addition, the massive machine-type communication may also be referred to as massive internet of things services. 5G features low power consumption, massive connections, a low latency, and high reliability, well adapts to internet of things services, and can be mainly used to resolve a problem that traditional mobile communication cannot well support internet of things and vertical industry applications. Scenarios with low power consumption and massive connections are mainly oriented to application scenarios such as a smart city, environment monitoring, intelligent agriculture, and forest fire prevention that aim at sensing and data collection. These scenarios feature small data packets, low power consumption, massive connections, and the like. These terminals are widely distributed and numerous. Therefore, a network needs to support more than 100 billion connections, and meet a requirement on a connection density indicator of 1 million connections per square kilometer. In addition, ultra-low power consumption and ultra-low costs of a terminal need to be ensured.

### 4. Grant-Free (Grant-Free) GF Resource

All communication resources related to GF transmission are GF resources, for example, a time domain resource, a frequency domain resource, or a code domain resource required for data transmission, or a sequence resource required for reference signal transmission. The GF resource may be divided in a plurality of dimensions. For example, the GF resource may be divided into a subframe (subframe)/slot (slot)/symbol (symbol) in time domain; may be divided into a subband (subband)/resource block (Resource Block)/resource element (Resource Element) in frequency domain; or may be divided into a plurality of spreading codewords or codeword groups, or a plurality of signatures (signatures) or a plurality of signature groups in code domain.

Signaling (for example, first indication information) of a network device may be delivered in a broadcast or multicast manner, for example, delivered by using radio resource control (radio resource control, RRC) signaling, a media access control element (media access control control element, MAC CE), or a dedicated physical layer feedback channel. The signaling of the network device may be for all GF users in a cell, or may be for only a part of GF users in the cell.

There are two entities in a communication system, and one entity can send information to the other entity or receive information sent by the other entity. The information herein may be a physical signal such as a preamble or a reference signal; physical layer control information such as downlink control information (downlink control information, DCI) and a new uplink control signal (uplink control information, UCI); control plane (control plane, CP) data such as a radio resource control (radio resource control, RRC) message; user plane (user plane, UP) data; or other information related to a specific scenario or application, such as related data (such as gradient information, training data, and model parameters) generated by or by enabling artificial intelligence (artificial intelligence, AI) or machine learning (machine learning, ML), or related data by enabling a sensing (sensing) function or generated by sensing.

The GF resource is periodically configured. A network system divides a GF resource in each periodicity into several resource blocks. As shown in FIG. 2, if there is data needs to be transmitted, a user equipment selects a plurality of resource blocks in a GF periodicity to complete sending of the data. As shown in FIG. 2, in one GF configuration periodicity, the user equipment sends information to a network device on a selected GF resource. The network device detects usage of each GF resource block, and predicts usage of the GF resource in a next GF periodicity. The network device sends the usage of the GF resource to the user equipment in the next periodicity in advance. As shown in FIG. 2, in one GF configuration periodicity, the network device sends related information of the usage of the GF resource to the user equipment. The user equipment chooses, based on the usage of the GF resource sent by the network device, whether to continue to use a GF resource selected in a previous periodicity or to adjust a used GF resource. When the user equipment chooses to adjust the used GF resource, the user equipment reselects a resource, and congestion of the GF resource may be caused by different reasons. For example, currently, many users select a same resource for transmission. As a result, a probability that a collision occurs is high. Alternatively, the resource is pre-allocated to and occupied by another service in a next transmission process. For the foregoing former case, the user equipment generally only needs to reselect a resource for transmission, and does not need to deliberately avoid a resource on which a collision occurs. For the foregoing latter case, because the resource is clearly occupied in a next time of transmission, the user equipment should avoid the resource as much as possible when reselecting a resource for transmission.

It should be noted that the grant-free resource configuration method provided in this application may be based on dynamic grant transmission, or may be used for grant-free transmission (for example, 2-step random access (2-step random access, 2-step RA), 4-step random access (4-step random access, 4-step RA), a pre-configured uplink resource (pre-configured uplink resource, PUR), or a configured grant (configured grant, CG)). This is not limited in this application.

It should be further noted that this application is applicable to a high-frequency scenario (for example, a millimeter wave or THz scenario), and is also applicable to a low-frequency scenario (for example, a frequency band of 700/900 MVHz or 2.1/2.6/3.5 GHz). This application may be used in a licensed (licensed) frequency band, or may be used in an unlicensed (unlicensed) frequency band. This application may be used for an air interface Uu link between a terminal and a base station, may be used for a sidelink (sidelink) such as D2D, or may be used for a non-terrestrial network (non-terrestrial network, NTN) communication link. This application may be used for a terminal in a connected state or an active state (ACTIVE), may be used for a terminal in a non-connected state (INACTIVE) or an idle state (IDLE), or may be used for a terminal that is not in the foregoing three states, for example, a terminal device that is not attached to a network or does not perform downlink synchronization with a network. This is not limited in this application.

In a GF resource mechanism, a transmission mode similar to that in slotted ALOHA (Slotted ALOHA) is usually used. To be specific, a network device first pre-allocates a plurality of GF resources, and a user equipment selects one or more resources from the plurality of pre-allocated GF resources based on a rule or randomly, where each GF transmission resource may be defined in different dimensions, for example, in time domain, frequency domain, and code domain. FIG. 3 shows a transmission method for periodic configuration of a grant-free resource. The transmission method shown in FIG. 3 is a transmission mode in coded slotted ALOHA (Coded Slotted ALOHA). A dark block in FIG. 3 represents a resource block selected by the user equipment for information transmission. As shown in FIG. 3, a user 1 selects four resources 2, 10, 14, and 20 for transmission in a current transmission process, and a user 4 also selects the four resources 2, 10, 14, and 20 for transmission. The user 1 and the user 4 select same resources in the transmission process, and another user may select the four resources 2, 10, 14, and 20 in the current transmission process. It can be learned that, when a plurality of user equipments select a GF resource, there is no good mutual coordination mechanism. Therefore, a case in which a plurality of users select a same resource, in other words, a resource collision occurs. As a result, transmission performance is reduced.

Generally, adverse impact of the resource collision may be reduced in two manners:

(1) A transmitting end (for example, a user equipment) selects a plurality of GF resources, to reduce a probability that a collision occurs in current transmission. A same signal may be sent on a plurality of resources, for example, contention resolution diversity slotted ALOHA (contention resolution diversity slotted ALOHA, CRDSA) or irregular repetition ALOHA (irregular repetition ALOHA, IRSA), or different signals may be sent in a coding manner, for example, coded ALOHA.

(2) A receiving end (for example, a network device) can ensure, by using a technology similar to an interference cancellation (interference cancellation, IC) technology, by increasing a quantity of antennas, or by using another manner to enhance a receiving capability, that user information can still be correctly received when a quantity of collision users is not very large.

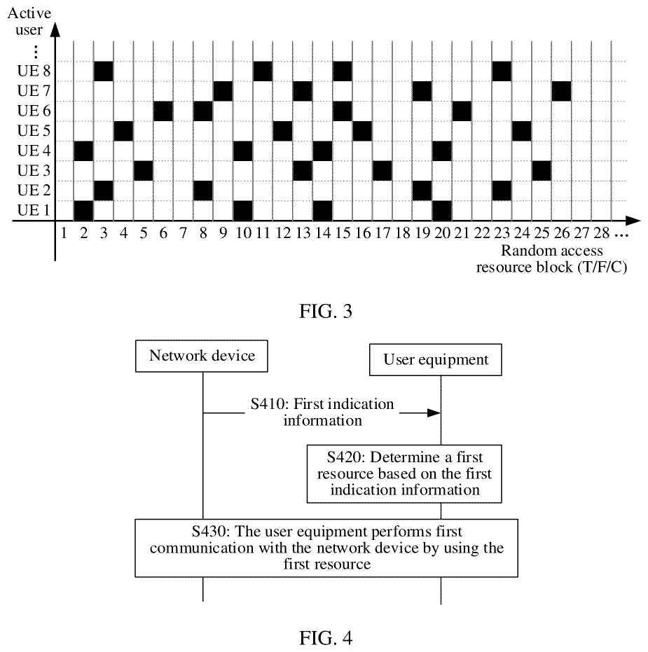

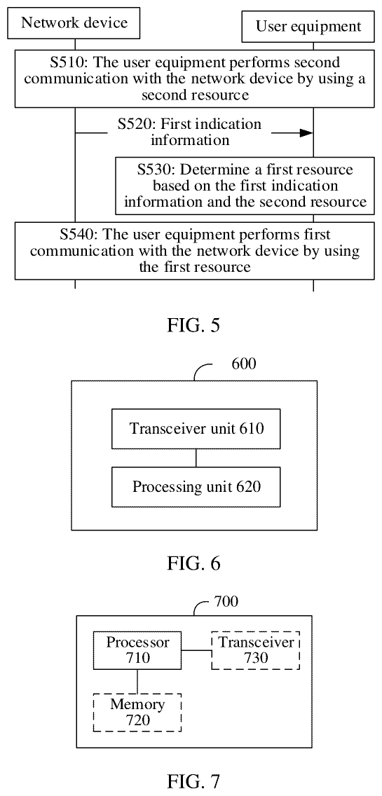

In the foregoing two manners, the adverse impact caused by the resource collision is reduced, but a problem that resources by selected users are not scheduled is not fundamentally resolved, and a problem of a resource collision between a plurality of users is still caused. When a quantity of users on a resource block exceeds a demodulation capability of a receiver (a network device), performance of access of the plurality of users is reduced sharply. To better alleviate the problem of the resource collision between the plurality of users, this application provides a grant-free resource configuration method. For a specific implementation, refer to FIG. 4 and FIG. 5. To avoid redundancy, details are not described herein.

For ease of understanding of embodiments of this application, the following should be noted.

1. Because a GF resource is configured based on a periodicity, the GF resource in this application indicates a GF resource block group in a current GF periodicity. Specifically, when it is assumed that the GF resource is configured in a time-frequency manner, a GF resource block group is determined in a current GF periodicity by using related specific parameters of GF resource block groups in a previous GF periodicity and the current periodicity. In an example, when the GF resource is configured in the time-frequency manner, in a first GF periodicity, a user equipment communicates with a network device on a first GF resource block group (for example, a second resource in FIG. 5 in embodiments of this application), and in a second GF periodicity, the user equipment communicates with the network device. When the user equipment continues to select the first GF resource block group used in the first GF periodicity, the first GF resource block group selected by the user equipment in the second GF periodicity is determined by a time-frequency location obtained based on an offset of a start location of the second GF periodicity, where a value the offset is determined by a time-frequency location of the first GF resource block group in the first GF periodicity, and the first GF periodicity is before the second GF periodicity.

2. In this application, that a status of a GF resource block group is a congested state or an idle state may be obtained by the network device by collecting statistics on current occupation of a resource block group in a GF resource by a user. Alternatively, the status of the resource block group may be a status of the resource block group obtained by the network device by processing based on current occupation of a resource block group by the user or previous occupation by the user, and the status of the resource block group is predicted by the network device. Alternatively, the status of the resource block group is determined by the network device based on preoccupation of a GF resource by some users. There may be another method for determining the status of the resource block group. This is not limited in this application.

In an example, when a quantity of users on a same resource block in a same periodicity exceeds a threshold preset by the network device, the status is the congested state. For example, if the threshold preset by the network device is 3, and the quantity of users occupying the same resource block in the same periodicity is 5, the status of the resource block is the congested state. When the quantity of users on the same resource block in the same periodicity does not exceed the threshold preset by the network device, the status is the idle state. For example, if the threshold preset by the network device is 2, and the quantity of users occupying the resource block group in the same periodicity is 1, the resource block group is idle.

3. One resource block group in this application may include one resource block, or may include a plurality of resource blocks. When one resource block group includes one resource block, and the resource block is congested or idle, the resource block group is congested or idle. When one resource block group includes a plurality of resource blocks, a status of the resource block group is determined by the network device. For example, when one resource block group includes 10 resource blocks, when statuses of all resource blocks are idle or congested, the network device determines that the status of the resource block group is idle or congested. Alternatively, when one of the resource blocks is idle or congested, the network device determines that the status of the resource block group is idle or congested. Alternatively, after the network device averages quantities of users who occupy the 10 resource blocks, the network device determines, based on a quantity of users on each resource block, that the status of the resource block group is idle or congested. There are a plurality of manners in which the network device determines whether a status of a resource block group is an idle state or a congested state. This is not limited in this application.

FIG. 4 is a diagram of a grant-free resource configuration method according to an embodiment of this application. A user equipment receives first indication information from a network device, where the first indication information indicates a status of each resource block group in a GF resource; the user equipment determines a first resource based on the first indication information; and the user equipment performs first communication with the network device by using the first resource, so that a possibility of a resource collision in a communication process between the user equipment and the network device can be effectively reduced, and transmission performance of the user equipment can be improved. The method shown in FIG. 4 includes the following step:

S410: The user equipment receives first indication information from the network device, where the first indication information indicates a status of each resource block group in a grant-free GF resource, the GF resource includes one or more resource block groups, each resource block group includes at least one resource block, and a status of one resource block group includes a congested state or an idle state.

Optionally, the status of the resource block group further includes a congestion level and an idle level.

It should be understood that the status of the resource block group includes not only the congested state or the idle state but also the congestion level and the idle level of the resource block group. For example, the congestion level may be classified into a high congestion level, a medium congestion level, or a low congestion level, and the idle level may also be classified into a high idle level, a medium idle level, or a low idle level. Specifically, there may be another classification for the level. This is not limited in this application. The user equipment determines a first resource based on the congestion level and the idle level of the resource block group, so that a resource collision can be more effectively reduced.

In an example, the congestion level is classified into the high congestion level, the medium congestion level, or the low congestion level, and the idle level is classified into the high idle level, the medium idle level, or the low idle level. When a quantity of users occupying a same resource block group for transmission exceeds a first threshold preset by the network device, the resource block group is at the high congestion level. When a quantity of users occupying a same resource for transmission does not exceed a first threshold preset by the network device and exceeds a second threshold preset by the network device, the resource is at the medium congestion level. When a quantity of users occupying a same resource for transmission does not exceed a second threshold preset by the network device and exceeds a third threshold preset by the network device, the resource is at the low congestion level. When a quantity of users occupying a same resource for transmission does not exceed a fourth threshold preset by the network device, the resource is at the high idle level. When a quantity of users occupying a same resource for transmission exceeds a fourth threshold preset by the network device and does not exceed a fifth threshold preset by the network device, the resource is at the medium idle level. When a quantity of users occupying a same resource for transmission exceeds a fifth threshold preset by the network device and does not exceed a sixth threshold preset by the network device, the resource is at the low idle level. Certainly, the status of the GF resource block group may alternatively be divided into another level. This is not limited in this application.

Optionally, the first indication information further indicates a selection weight of one or more resource block groups, or the first indication information further indicates a selection weight of a resource block group in the congested state and/or a selection weight of a resource block group in the idle state.

It should be understood that, the user equipment determines the first resource based on the selection weight of the one or more resource block groups or based on the selection weight of the resource block group in the congested state and/or the selection weight of the resource block group in the idle state, so that transmission performance of the user equipment can be effectively improved.

Optionally, when a third resource in the GF resource is invoked by a non-GF service, the first indication information further indicates that the third resource cannot be used by the user equipment. Therefore, a first resource does not include the third resource.

It should be understood that, when a resource block group has been invoked by a non-GF resource service, selection probability information of the resource block group is zero, and when selecting the first resource, the user equipment avoids the occupied resource block group to perform selection.

Optionally, the first indication information includes: an index of the resource block group in the congested state in the GF resource; an index of the resource block group in the idle state in the GF resource; or a first bitmap, where the first bitmap includes N bits, the GF resource includes N resource block groups, the N bits are in one-to-one correspondence with the N resource block groups, and each bit indicates a status of a corresponding resource block group.

It should be understood that a congested resource block group and an idle resource block group in the GF resource may be represented by using indexes of the resource block groups. For example, the index of the resource block group is represented by using a sequence number of the GF resource block group. When a sequence number of a resource block group is “1”, it indicates that the resource block group is congested; or when a sequence number of a resource block group is “0”, it indicates that the resource block group is idle. Alternatively, when a sequence number of a resource block group is “0”, it indicates that the resource block group is congested; or when a sequence number of a resource block group is “1”, it indicates that the resource block group is idle. This is not limited in this application.

It should be further understood that the first indication information includes the first bitmap, where the first bitmap includes the N bits, the GF resource includes the N resource block groups, the N bits are in one-to-one correspondence with the N resource block groups, and each bit indicates the status of the corresponding resource block group. For example, each resource block group in the GF resource may be represented by using a bitmap (bitmap). A bitmap of the GF resource includes a string of digits 0 and 1, and each digit “0” or “1” corresponds to one GF resource block. For example, “1” indicates that the GF resource block is marked, and “0” indicates that the GF resource block is not marked. Alternatively, “0” indicates that the GF resource block is marked, and “1” indicates that the GF resource block is not marked. When “0” indicates that the resource block group is marked as congested or idle, “1” indicates that the resource block group is not marked. When “1” indicates that the resource block group is marked as congested or idle, “0” indicates that the resource block group is not marked. Alternatively, “1” indicates that the resource block group is congested, and “0” indicates that the resource block group is idle. Alternatively, “0” indicates that the resource block group is congested, and “1” indicates that the resource block group is idle. The user equipment determines the first resource based on a received bitmap of a resource block group. Further, in a possible implementation method, the first bitmap may include a N bits, corresponding to the N resource block groups. In a manner agreed on in advance, a congestion level and/or an idle level of each resource block group are/is represented by using a bits. Without a loss of generality, this application is described by using an example in which the first bit includes N bits, that is, a=1.

Further, after receiving the first indication information from the network device, the user equipment determines, based on the first indication information, the first resource used for first communication with the network device. As shown in the method in FIG. 4, the method further includes the following step:

S420: The user equipment determines the first resource based on the first indication information, where the first resource is determined based on the first indication information, and the first resource is at least one resource block group in the GF resource.

It should be understood that, when the user equipment determines, based on the first indication information, the first resource used for the first communication, the user equipment may randomly select and determine the first resource from the GF resource, or the user equipment may determine the first resource based on the first indication information. The user equipment may determine the first resource based on the status of the resource block group, a state level of the resource block group, or the selection weight of the resource block group indicated in the first indication information.

In an example, when the user equipment performs the first communication with the network device by using the first resource in the GF resource, the user equipment selects the first resource in the following several manners:

Manner 1: The user equipment selects the first resource from the resource block group with an equal probability.

The user equipment selects the first resource from the GF resource with the equal probability. For example, the GF resource includes 10 resource block groups, and a probability that the user equipment selects each resource block group as the first resource is one-tenth.

When the first indication information indicates a resource block group in the congested state in the resource block groups, the user equipment excludes the resource block group in the congested state indicated in the first indication information, and selects the first resource from a non-congested GF resource with the equal probability. For example, the GF resource includes the 10 resource block groups, where the first indication information indicates that two of the resource block groups are in the congested state. The user equipment excludes the two resource block groups in the congested state, and performs selection from the remaining eight non-congested resource block groups with the equal probability. A selection probability for the user equipment is one-eighth. Therefore, each selected resource block group is in a non-congested state, so that a possibility that a resource collision occurs on the user equipment is reduced.

When the first indication information indicates a resource block group in the idle state in the resource block groups, the user equipment selects the first resource from the resource block group in the idle state with the equal probability. For example, the GF resource includes the 10 resource block groups, where the first indication information indicates that four of the resource block groups are idle. The user equipment performs selection from the four resource block groups in the idle state with the equal probability. A selection probability for the user equipment is a quarter. Therefore, each first resource selected by the user equipment is in the idle state, and the user equipment communicates with the network device on the first resource, so that a problem of a resource collision in a communication process can be effectively reduced.

Manner 2: The user equipment selects the first resource from the resource block group with unequal probabilities.

The user equipment changes a selection probability of the resource block group based on the selection weight of the resource block group indicated in the first indication information, and the user equipment selects the first resource from the resource block group with the unequal probabilities. A larger selection weight of the resource block group indicates a larger selection probability of the resource block group. A smaller selection weight of the resource block group indicates a smaller selection probability of the resource block group.

When the first indication information indicates a selection weight of a resource block group in the congested state, the user equipment reduces a selection probability of the congested resource block group based on the selection weight of the congested resource block group, and a probability that the user equipment selects the congested resource block group from the GF resource block group as the first resource is reduced, so that a possibility of a resource collision in a communication process between the user equipment and the network device is reduced.

When the first indication information indicates a selection weight of a resource block group in the idle state, the user equipment increases a selection probability of the idle resource block group based on the selection weight of the idle resource block group, and a probability that the user equipment selects the idle resource block group from the GF resource block group as the first resource increases, so that a possibility of a resource collision in a communication process between the user equipment and the network device is reduced, and a transmission success rate is increased.

When the first indication information indicates a selection weight of a resource block group in the congested state and a selection weight of a resource block group in the idle state, the user equipment separately reduces the selection probability of the congested resource block group and increases the selection probability of the idle resource block group based on the selection weight of the congested resource block group and the selection weight of the idle resource block group, so that a probability that the user equipment selects the idle resource block group from the GF resource block group as the first resource is increased, and a probability that the user equipment selects the congested resource block group from the GF resource block group as the first resource is reduced. Therefore, a possibility of a resource collision in a communication process between the user equipment and the network device is greatly reduced, and a transmission success rate is increased.

When the first indication information indicates a selection weight of a resource block group in the congested state and a selection weight of a resource block group in the idle state, the user equipment excludes the resource block group in the congested state in the first indication information, and increases a selection probability of the idle resource block group based on the selection weight of the idle resource block group, so that a probability that the user equipment selects the idle resource block group from a non-congested GF resource block group as the first resource is increased, and when the user equipment selects the first resource, the congested resource block group indicated in the first indication information is avoided. Therefore, a possibility of a resource collision in a communication process between the user equipment and the network device is reduced, and a transmission success rate is increased.

Further, the user equipment performs the first communication with the network device by using the first resource. As shown in the method in FIG. 4, the method further includes the following step:

S430: The user equipment performs the first communication with the network device by using the first resource.

Optionally, content of the first communication performed by the user equipment and the network device includes one or more of the following: a reference signal, a preamble, a physical uplink shared channel (physical uplink shared channel, PUSCH), a physical uplink control channel (physical uplink control channel, PUCCH), UCI, an RRC message, and control plane data.

Based on the method shown in FIG. 4, the user equipment performs the first communication with the network device based on the first indication information by using the first resource, so that the resource collision in the communication process between the user equipment and the network device can be effectively reduced, and the transmission performance of the user equipment can be improved.

FIG. 5 is a diagram of another grant-free resource configuration method according to an embodiment of this application. Before a user equipment receives first indication information from a network device, the user equipment selects a second resource to perform second communication with the network device, and the second communication fails. After receiving the first indication information from the network device, the user equipment determines a first resource based on the first indication information and the second resource, to improve a transmission success rate of the user equipment. The method shown in FIG. 5 includes the following step:

S510: The user equipment performs second communication with the network device by using a second resource.

It should be understood that the user equipment selects the second resource from a GF resource based on a rule or randomly, and performs the second communication with the network device based on the second resource, where the second communication fails.

Further, the user equipment receives first indication information from the network device, and the user equipment reselects a resource based on the first indication information, to perform first communication with the network device. The method shown in FIG. 5 further includes the following step:

S520: The network device sends the first indication information to the user equipment, or the user equipment receives the first indication information from the network device.

It should be understood that the first indication information indicates a state of a grant-free GF resource, the GF resource includes one or more resource block groups, each resource block group includes at least one resource block, and a status of the resource block group includes a congested state or an idle state.

Optionally, the status of the resource block group further includes a congestion level and an idle level.

Optionally, the first indication information further indicates a selection weight of one or more resource block groups, or the first indication information further indicates a selection weight of a resource block group in the congested state and/or a selection weight of a resource block group in the idle state. For details, refer to specific descriptions in step S410 in FIG. 4. To avoid repetition, details are not described herein again.

The user equipment receives the first indication information from the network device, and determines a first resource based on the first indication information and the second resource. As shown in the method in FIG. 5, the method further includes the following step:

S530: The user equipment determines the first resource based on the first indication information and the second resource.

It should be understood that, when the user equipment determines the first resource based on the first indication information and the second resource, the user equipment may exclude the second resource and select the first resource from remaining GF resource block groups, or the user equipment reduces a weight of the second resource, and selects the first resource from all resource block groups in the GF resource.

When the user equipment excludes the second resource and selects the first resource from remaining GF resources, for a specific selection method, refer to descriptions in step S420 in FIG. 4. To avoid redundancy, details are not described herein again.

When the user equipment reduces the selection weight of the second resource, and determines the first resource from the GF resource block group, for a specific detailed step, refer to step S420 in FIG. 4. To avoid redundancy, details are not described herein again.

Further, the user equipment determines the first resource based on the first indication information and the second resource, and performs the first communication with the network device based on the first resource. As shown in the method in FIG. 5, the method further includes the following step: S540: The user equipment performs the first communication with the network device by using the first resource.

Based on the method shown in FIG. 5, when the user equipment performs the second communication with the network device by using the second resource, the second communication fails. After the user equipment receives the first indication information from the network device, the user equipment determines the first resource based on the first indication information and the second resource, and then the user equipment performs the first communication with the network device based on the determined first resource. Therefore, communication performance between the user equipment and the network device is improved, and a transmission success rate of the user equipment is increased.

It should be noted that FIG. 5 in this application shows only an example, and the user equipment is not limited to determining the first resource based on the first indication information and the second resource when the second communication fails. When the second communication between the user equipment and the network device succeeds, after the user equipment receives the first indication information from the network device, the user equipment may also determine the first resource based on the first indication information and the second resource. When the second communication succeeds, the user equipment may also determine the first resource based on the first indication information and the second resource, or the user equipment continues to perform the first communication by using the second resource. When the second communication fails, the user equipment may also continue to perform the first communication by using the second resource.

It should be further noted that, when the user equipment and the network device need to perform the first communication, and the second resource used for the second communication is not indicated by the first indication information as a congested GF resource block group, the user equipment needs to perform the first communication with the network device by using the second resource based on configuration information of a network or a protocol specification of the user equipment.

The foregoing describes in detail a grant-free resource configuration method in embodiments of this application with reference to FIG. 4 and FIG. 5. The following describes in detail a grant-free resource configuration apparatus provided in embodiments of this application with reference to FIG. 6 and FIG. 7. It should be understood that descriptions of apparatus embodiments correspond to the descriptions of the method embodiments. Therefore, for content that is not described in detail, refer to the foregoing method embodiments. For brevity, some content is not described again.

FIG. 6 is a schematic block diagram of a grant-free resource configuration apparatus according to an embodiment of this application. The apparatus 600 includes a transceiver unit 610 and a processing unit 620. The transceiver unit 610 may be configured to implement a corresponding communication function. The transceiver unit 610 may also be referred to as a communication interface or a communication unit. The processing unit 620 may be configured to implement a corresponding processing function, for example, modifying an address.

Optionally, the apparatus 600 further includes a storage unit. The storage unit may be configured to store instructions and/or data. The processing unit 620 may read the instructions and/or the data in the storage unit, so that the apparatus implements actions of the device or the network element in the foregoing method embodiments.

Optionally, the apparatus 600 may further include the processing unit 620, and the processing unit 620 may be configured to perform data processing.

Optionally, the apparatus 600 further includes a storage unit. The storage unit may be configured to store instructions and/or data. The processing unit 620 may read the instructions and/or the data in the storage unit, so that the apparatus implements actions of different terminal devices in the foregoing method embodiments, for example, actions of a user equipment.

The apparatus 600 may be configured to perform actions performed by the user equipment or the network device in the foregoing method embodiments. In this case, the apparatus 600 may be the user equipment or the network device, or a component of the user equipment or the network device. The transceiver unit 610 is configured to perform receiving and sending-related operations of the user equipment or the network device in the foregoing method embodiments. The processing unit 620 is configured to perform processing-related operations of the user equipment or the network device in the foregoing method embodiments.

It should be understood that the apparatus 600 herein is embodied in a form of a functional unit. The term “unit” herein may refer to an application-specific integrated circuit (application-specific integrated circuit, ASIC), an electronic circuit, a processor (for example, a shared processor, a dedicated processor, or a group processor) configured to execute one or more software or firmware programs, a memory, a merged logic circuit, and/or another appropriate component that supports the described function. In an optional example, a person skilled in the art may understand that the apparatus 600 may be specifically the user equipment or the network device in the foregoing embodiments, and may be configured to perform procedures and/or steps corresponding to the user equipment or the network device in the foregoing method embodiments. Alternatively, the apparatus 600 may be specifically the user equipment or the network device in the foregoing embodiments, and may be configured to perform procedures and/or steps corresponding to the user equipment or the network device in the foregoing method embodiments. To avoid repetition, details are not described herein again.

The apparatus 600 in each of the foregoing solutions has a function of implementing a corresponding step performed by the user equipment or the network device in the foregoing method, or the apparatus 600 in each of the foregoing solutions has a function of implementing a corresponding step performed by the user equipment or the network device in the foregoing method. The function may be implemented by hardware, or may be implemented by hardware executing corresponding software. The hardware or the software includes one or more modules corresponding to the foregoing function. For example, the transceiver unit may be replaced by a transceiver (for example, a sending unit in the transceiver unit may be replaced by a transmitter, and a receiving unit in the transceiver unit may be replaced by a receiver), and another unit, for example, the processing unit, may be replaced by a processor, to separately perform a sending and receiving operation and a related processing operation in the method embodiments.

In addition, the transceiver unit 610 may alternatively be a transceiver circuit (for example, may include a receiving circuit and a sending circuit), and the processing unit may be a processing circuit.

It should be noted that the apparatus in FIG. 6 may be the network element or the device in the foregoing embodiments, or may be a chip or a chip system, for example, a system-on-a-chip (system-on-a-chip, SoC). The transceiver unit may be an input/output circuit or a communication interface. The processing unit is a processor, a microprocessor, or an integrated circuit integrated on the chip. This is not limited herein.

FIG. 7 is a schematic block diagram of another grant-free resource configuration apparatus according to an embodiment of this application. The apparatus 700 includes a processor 710. The processor 710 is configured to execute a computer program or instructions stored in a memory 720, or read data/signaling stored in the memory 720, to perform the methods in the foregoing method embodiments. Optionally, there are one or more processors 710.

Optionally, as shown in FIG. 7, the apparatus 700 further includes the memory 720, and the memory 720 is configured to store the computer program or the instructions and/or the data. The memory 720 may be integrated with the processor 710, or may be disposed separately. Optionally, there are one or more memories 720.

Optionally, as shown in FIG. 7, the apparatus 700 further includes a transceiver 730, and the transceiver 730 is configured to receive and/or send a signal. For example, the processor 710 is configured to control the transceiver 730 to receive and/or send a signal.

In a solution, the apparatus 700 is configured to implement operations performed by the network element in the foregoing method embodiments.

For example, the processor 710 is configured to execute the computer program or the instructions stored in the memory 720, to implement related operations in the foregoing method embodiments, for example, the method of the user equipment and/or the network device in the embodiment shown in FIG. 4.

It should be understood that, the processor mentioned in embodiments of this application may be a central processing unit (central processing unit, CPU), and may further be another general-purpose processor, a digital signal processor (digital signal processor, DSP), an application-specific integrated circuit (application-specific integrated circuit, ASIC), a field programmable gate array (field programmable gate array, FPGA) or another programmable logic device, a discrete gate or a transistor logic device, a discrete hardware component, or the like. The general-purpose processor may be a microprocessor, or the processor may be any conventional processor or the like.

It should be further understood that the memory mentioned in embodiments of this application may be a volatile memory and/or a non-volatile memory. The nonvolatile memory may be a read-only memory (read-only memory, ROM), a programmable read-only memory (programmable ROM, PROM), an erasable programmable read-only memory (erasable PROM, EPROM), an electrically erasable programmable read-only memory (electrically EPROM, EEPROM), or a flash memory. The volatile memory may be a random access memory (random access memory, RAM). For example, the RAM may be used as an external cache. By way of example, and not limitation, the RAM includes a plurality of forms, such as a static random access memory (static RAM, SRAM), a dynamic random access memory (dynamic RAM, DRAM), a synchronous dynamic random access memory (synchronous DRAM, SDRAM), a double data rate synchronous dynamic random access memory (double data rate SDRAM, DDR SDRAM), an enhanced synchronous dynamic random access memory (enhanced SDRAM, ESDRAM), a synchlink dynamic random access memory (synchlink DRAM, SLDRAM), and a direct rambus random access memory (direct rambus RAM, DR RAM).

It should be noted that when the processor is a general purpose processor, a DSP, an ASIC, an FPGA or another programmable logic device, a discrete gate or a transistor logic device, or a discrete hardware component, a memory (storage module) may be integrated into the processor.

It should further be noted that the memory described herein is intended to include, but is not limited to, these and any other suitable type of memory.

An embodiment of this application further provides a computer-readable storage medium. The computer-readable storage medium stores computer instructions used to implement the method performed by the user equipment and/or the network device in the foregoing method embodiments.

For example, when a computer program is executed by a computer, the computer is enabled to implement the method performed by the user equipment and/or the network device in the foregoing method embodiments.

An embodiment of this application further provides a computer program product, including instructions. When the instructions are executed by a computer, the method performed by the user equipment and/or the network device in the foregoing method embodiments is implemented.

An embodiment of this application further provides a system, including the foregoing user equipment and/or the foregoing network device.

For explanations and beneficial effect of related content of any one of the apparatuses provided above, refer to the corresponding method embodiment provided above. Details are not described herein again.

In the several embodiments provided in this application, it should be understood that the disclosed apparatus and method may be implemented in other manners. For example, the described apparatus embodiment is merely an example. For example, division into the units is merely logical function division and may be other division in actual implementation. For example, a plurality of units or components may be combined or integrated into another system, or some features may be ignored or not performed. In addition, the displayed or discussed mutual couplings or direct couplings or communication connections may be implemented through some interfaces. The indirect couplings or communication connections between the apparatuses or units may be implemented in electronic, mechanical, or other forms.

In addition, function units in embodiments of this application may be integrated into one processing unit, each of the units may exist alone physically, or two or more units are integrated into one unit.

The term “and/or” in this application is merely an association relationship for describing associated objects, and indicates that three relationships may exist. For example, A and/or B may represent: Only A exists, both A and B exist, and only B exists. A, B, and C may all be singular or plural, and are not limited. “A plurality of” in this application means two or more than two.

In embodiments of this application, numbers “first” and “second” are used to distinguish between same items or similar items having basically same functions and functions. A person skilled in the art can understand that “first” and “second” do not limit a quantity or a sequence, and “first”, “second”, and the like do not limit a necessary difference.

All or some of the foregoing embodiments may be implemented by using software, hardware, firmware, or any combination thereof. When software is used to implement embodiments, all or a part of embodiments may be implemented in a form of a computer program product. The computer program product includes one or more computer instructions. When the computer program instructions are loaded and executed on the computer, the procedure or functions according to embodiments of this application are all or partially generated. The computer may be a general-purpose computer, a dedicated computer, a computer network, or other programmable apparatuses. For example, the computer may be a personal computer, a server, a network device, or the like. The computer instructions may be stored in a computer-readable storage medium or may be transmitted from a computer-readable storage medium to another computer-readable storage medium. For example, the computer instructions may be transmitted from a website, computer, server, or data center to another website, computer, server, or data center in a wired (for example, a coaxial cable, an optical fiber, or a digital subscriber line (DSL)) or wireless (for example, infrared, radio, or microwave) manner. The computer-readable storage medium may be any usable medium accessible by the computer, or a data storage device, for example, a server or a data center, integrating one or more usable media. The usable medium may be a magnetic medium (for example, a floppy disk, a hard disk, or a magnetic tape), an optical medium (for example, a DVD), a semiconductor medium (for example, a solid-state disk (solid-state disk, SSD)), or the like. For example, the usable medium may include but is not limited to any medium that can store program code, for example, a USB flash drive, a removable hard disk, a read-only memory (read-only memory, ROM), a random access memory (random access memory, RAM), a magnetic disk, or an optical disc.

The foregoing descriptions are merely specific implementations of this application, but are not intended to limit the protection scope of this application. Any variation or replacement readily figured out by a person skilled in the art within the technical scope disclosed in this application shall fall within the protection scope of this application. Therefore, the protection scope of this application shall be subject to the protection scope of the claims.

What is claimed is:

1. A grant-free resource configuration method for a user equipment, comprising:
receiving, first indication information from a network device, wherein the first indication information indicates a status of each resource block group in a grant-free (GF) resource, the GF resource comprises one or more resource block groups, each resource block group comprises at least one resource block, and the status comprises a congested state or an idle state; and
performing, first communication with the network device by using a first resource, wherein the first resource is determined based on the first indication information, and the first resource is at least one resource block group in the GF resource.

2. The method according to claim 1, wherein that the first resource is determined based on the first indication information comprises:
the first resource is determined based on the first indication information and a second resource, wherein the second resource is at least one resource block group in the GF resource, the second resource is a resource used for second communication between the user equipment and the network device, the second communication fails, and the second communication is performed before the first communication.

3. The method according to claim 1, wherein the status further comprises a congestion level and/or an idle level.

4. The method according to claim 1, wherein the first indication information further indicates a selection weight of one or more resource block groups, or the first indication information further indicates a selection weight of a resource block group in the congested state and/or a selection weight of a resource block group in the idle state.

5. The method according to claim 1, wherein the first resource does not comprise a third resource, and the third resource is at least one resource block group in the GF resource.

6. The method according to claim 5, wherein the third resource is a resource invoked by a non-GF service.

7. The method according to claim 1, wherein the first indication information comprises:
an index of the resource block group in the congested state in the GF resource;
an index of the resource block group in the idle state in the GF resource; or
a first bitmap, wherein the first bitmap comprises N bits, the GF resource comprises N resource block groups, the N bits are in one-to-one correspondence with the N resource block groups, and each bit indicates a status of a corresponding resource block group.

8. The method according to claim 1, wherein content of the first communication performed by the user equipment and the network device comprises one or more of the following:
a reference signal, a preamble, a physical uplink shared channel (PUSCH), a physical uplink control channel (PUCCH), an uplink control signal (UCI), a radio resource control (RRC) message, and control plane (CP) data.

9. A communication apparatus, comprising:
at least one processor; and
a non-transitory computer-readable medium including computer-executable instructions that, when executed by the at least one processor, cause the apparatus to carry out a method including:
receiving, first indication information from a network device, wherein the first indication information indicates a status of each resource block group in a grant-free (GF) resource, the GF resource comprises one or more resource block groups, each resource block group comprises at least one resource block, and the status comprises a congested state or an idle state; and
performing, first communication with the network device by using a first resource, wherein the first resource is determined based on the first indication information, and the first resource is at least one resource block group in the GF resource.

10. The communication apparatus according to claim 9, wherein that the first resource is determined based on the first indication information comprises:
the first resource is determined based on the first indication information and a second resource, wherein the second resource is at least one resource block group in the GF resource, the second resource is a resource used for second communication between the user equipment and the network device, the second communication fails, and the second communication is performed before the first communication.

11. The communication apparatus according to claim 9, wherein the status further comprises a congestion level and/or an idle level.

12. The communication apparatus according to claim 9, wherein the first indication information further indicates a selection weight of one or more resource block groups, or the first indication information further indicates a selection weight of a resource block group in the congested state and/or a selection weight of a resource block group in the idle state.

13. The communication apparatus according to claim 9, wherein the first resource does not comprise a third resource, and the third resource is at least one resource block group in the GF resource.

14. The communication apparatus according to claim 13, wherein the third resource is a resource invoked by a non-GF service.

15. The communication apparatus according to claim 9, wherein the first indication information comprises:
an index of the resource block group in the congested state in the GF resource;
an index of the resource block group in the idle state in the GF resource; or
a first bitmap, wherein the first bitmap comprises N bits, the GF resource comprises N resource block groups, the N bits are in one-to-one correspondence with the N resource block groups, and each bit indicates a status of a corresponding resource block group.

16. The communication apparatus according to claim 9, wherein content of the first communication performed by the user equipment and the network device comprises one or more of the following:
a reference signal, a preamble, a physical uplink shared channel (PUSCH), a physical uplink control channel (PUCCH), an uplink control signal (UCI), a radio resource control (RRC) message, and control plane (CP) data.

17. A communication apparatus, comprising:
at least one processor; and
a non-transitory computer-readable medium including computer-executable instructions that, when executed by the at least one processor, cause the apparatus to carry out a method including:
sending, first indication information to a user equipment, wherein the first indication information indicates a status of each resource block group in a grant-free GF resource, the GF resource comprises one or more resource block groups, each resource block group comprises at least one resource block, and the status comprises a congested state or an idle state; and
performing, first communication with the user equipment, wherein the first communication is performed on a first resource, the first resource is determined based on the first indication information, and the first resource is at least one resource block group in the GF resource.

18. The communication apparatus according to claim 17, wherein that the first resource is determined based on the first indication comprises:
the first resource is determined based on the first indication information and a second resource, wherein the second resource is at least one resource block group in the GF resource, the second resource is a resource used for second communication between the user equipment and the network device, the second communication fails, and the second communication is performed before the first communication.

19. The communication apparatus according to claim 17, wherein the first indication information further indicates a selection weight of one or more resource block groups, or the first indication information further indicates a selection weight of a resource block group in the congested state and/or a selection weight of a resource block group in the idle state.

20. The communication apparatus according to claim 17, wherein the first resource does not comprise a third resource, and the third resource is at least one resource block group in the GF resource.
